(19) United States
(12) Patent Application Publication
(10) Pub. No.: US 2021/0207240 A1
(43) Pub. Date: Jul. 8, 2021

(54) METHOD FOR LITHIUM PROCESSING

(71) Applicant: Lithtech Industries Pty Ltd, Queens Park (AU)

(72) Inventors: Adam Blunn, Goonellabah (AU); Scott Eastwood, Swan Bay (AU)

(21) Appl. No.: 17/249,032

(22) Filed: Feb. 17, 2021

Related U.S. Application Data
(63) Continuation of application No. PCT/AU2019/000098, filed on Aug. 17, 2019.

(30) Foreign Application Priority Data
Aug. 17, 2018 (AU) 2018903034

(51) Int. Cl. C22B 3/20; C22B 26/12; C22B 26/22; C22B 3/10

(52) U.S. Cl. CPC C22B 3/0098; C22B 3/10; C22B 26/22; C22B 26/12

(57) ABSTRACT

A method for improved processing of lithium metallurgical solutions comprises the steps of:
i. Directing a lithium leach solution containing magnesium to an electrochemical magnesium removal step to form a magnesium depleted lithium leach solution;
ii. Directing the magnesium depleted lithium leach solution of step i) to downstream concentration and recovery processes
wherein the electrochemical magnesium removal step is a 3-chamber electrochemical configuration to produce magnesium hydroxide precipitate and a separate hydrochloric acid stream, as recoverable by-products.

### TECHNICAL FIELD

The present invention relates to the improved method for processing lithium metallurgical solutions. More particularly, the present invention relates the removal of impurities from lithium metallurgical solutions during processing.

### BACKGROUND ART

The following discussion of the background art is intended to facilitate an understanding of the present invention only. The discussion is not an acknowledgment or admission that any of the material referred to is or was part of the common general knowledge as at the priority date of the application.

In all lithium process flowsheets a critical process step is to remove magnesium from a lithium brine to enable recovery of lithium of satisfactory purity. Typically, this is achieved using soda-ash in hard rock processing from pegmatites to precipitate magnesium and calcium that are solubilised with Lithium, while trying to minimise lithium losses.

In brines typically found in South America, the conventional process relies on prolonged evaporation to take calcium and magnesium through saturation. This usually results in the loss of up to 50% of lithium. By using evaporation to crystallise calcium and magnesium salts the use of soda ash is minimised. In both hard rock and salar brines, magnesium must be removed prior to lithium recovery.

A particular feature common to both brine and hard rock processing is the requirement to add reagents to remove magnesium as calcium and magnesium chloride are highly soluble. Lime and sodium carbonate, used to precipitate the magnesium, both contribute to the higher cost of hard rock processing. The use of lime to remove magnesium produces a tailings product with no residual value, due to its mixed nature and inclusion of multiple impurities.

Disadvantages of brine circuits are very clear and quantifiable. Utilising solar evaporation requires very large evaporation pans with significant capital cost. Solution purification results in up to 50% losses of lithium to crystallisation, and solution purification and ‘polishing’ requires chemical additional and solid waste generation with no appreciable value.

In current processing, magnesium is a waste product and creates significant expense in its separation from lithium.

There is currently no satisfactory process which enables the separation of magnesium from metallurgical solutions to produce magnesium and metal streams that are of sufficient purity to be economical.

The present invention seeks to overcome, or at least ameliorate, one or more of the deficiencies of the prior art mentioned above, or to provide the consumer with a useful or commercial choice.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

Throughout this specification, unless the context requires otherwise, the term “brine solution”, will be understood to include salt, seawater, and metallurgical solutions containing same.

Reference to metallurgical solutions throughout this specification will be deemed to apply to any metal sought to be recovered from a metal source material, including but not limited to an ore, hard rock, salar brine, or slurry.

Reference to metals will be deemed to include any metal, including but not limited to, lithium.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with an aspect of the present invention, there is provided a method for improved processing of lithium metallurgical solutions comprising the steps of:
i) Directing a lithium leach solution containing magnesium to an electrochemical magnesium removal step to form a magnesium depleted lithium leach solution;
ii) Directing the magnesium depleted lithium leach solution of step i) to downstream concentration and recovery processes
wherein the electrochemical magnesium removal step is a 3-chamber electrochemical configuration to produce magnesium hydroxide precipitate and a separate hydrochloric acid stream, as recoverable by-products.

In accordance with an aspect of the present invention, there is provided a method for improved processing of lithium metallurgical solutions comprising the steps of:
i) Directing a lithium leach solution containing magnesium to an electrochemical magnesium removal step to form a magnesium depleted lithium leach solution;
ii) Directing the magnesium depleted lithium leach solution of step i) to downstream concentration and recovery processes
wherein the electrochemical magnesium removal step is a 3-chamber electro/electrodialysis configuration to produce magnesium hydroxide precipitate and a separate hydrochloric acid stream, as recoverable by-products.

In accordance with an aspect of the present invention, there is provided a method for improved processing of lithium metallurgical solutions comprising the steps of:
i) Directing a lithium leach solution containing magnesium to an electrochemical magnesium removal step to form a magnesium depleted lithium leach solution;
ii) Directing the magnesium depleted lithium leach solution of step i) to downstream concentration and recovery processes
wherein the electrochemical magnesium removal step is a single stage 3-chamber electro/electrodialysis configuration to produce magnesium hydroxide precipitate and a separate hydrochloric acid stream, as recoverable waste products.

In accordance with a further aspect of the present invention there is provided an improved method for treating lithium leach solutions, comprising:
i) Directing a lithium leach solution containing magnesium to an electrochemical magnesium removal step to form a magnesium depleted lithium leach solution;
ii) Directing the magnesium depleted lithium leach solution of step i) to a polishing step to produce a treated pregnant leach solution (PLS); and
iii) Directing the treated PLS to conventional concentration and recovery steps to recover lithium as lithium carbonate;
   wherein the magnesium removal step further comprises:
   Directing the lithium leach solution of step i) to a cathode chamber of an electrochemical cell containing a cathode;
   Directing a sulfuric acid electrolyte solution to an anode chamber containing an anode;
   Separating the anode chamber from the cathode chamber with a central chamber, to form a 3-chamber cell, having an anion exchange membrane forming a boundary to the cathode chamber and the central chamber, and a cation exchange membrane forming a boundary to the anode chamber and the central chamber;
   Directing a dilute hydrochloric acid solution to the central chamber;
   Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid;

Precipitating magnesium as magnesium hydroxide in the cathode chamber to produce the magnesium depleted lithium solution.

In accordance with a still further aspect of the present invention there is provided a method for improved recovery of lithium from lithium leach solutions, comprising:
i) Directing a lithium leach solution containing magnesium to an electrochemical magnesium removal step to form a magnesium depleted lithium leach solution, a magnesium hydroxide precipitate and a separate hydrochloric acid stream;
ii) Separating the magnesium hydroxide from the magnesium depleted lithium leach solution in a solid/liquid separation step;
iii) Directing the separated magnesium depleted lithium leach solution of step ii) to a polishing step to produce a treated pregnant leach solution (PLS);
iv) Directing the treated PLS to conventional concentration and recovery steps to recover lithium as lithium carbonate;
   wherein the magnesium removal step further comprises:
   Directing the lithium leach solution of step i) to a 3-chamber electrochemical cell comprising a cathode chamber, an anode chamber, and a central chamber situated therebetween and having an anion exchange membrane forming a boundary to the cathode chamber and the central chamber, and a cation exchange membrane forming a boundary to the anode chamber and the central chamber;
   Feeding the lithium leach solution of step i) to the cathode chamber containing a cathode;
   Directing a sulphuric acid electrolyte solution to the anode chamber containing an anode;
   Directing a hydrochloric acid solution to the central chamber;
   Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid;
   Precipitating magnesium as magnesium hydroxide in the cathode chamber to produce the magnesium depleted lithium solution.

In preferred embodiments of the present invention, the method is adapted for processing lithium metallurgical solutions or lithium leach solutions as a stand-alone cell.

In preferred embodiments of the present invention, the method is adapted for processing lithium metallurgical solutions or lithium leach solutions as part of an inline continuous flow processing operation.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 depicts a flowsheet for the process of leaching a lithium material using the present invention.

FIG. 2 depicts an embodiment of the magnesium separation step.

FIG. 3 shows experimental results from applying the method of the present invention to a synthetic lithium leach solution.

FIG. 4 shows experimental results from applying the method of the magnesium separation step to a test lithium solution made up with seawater.

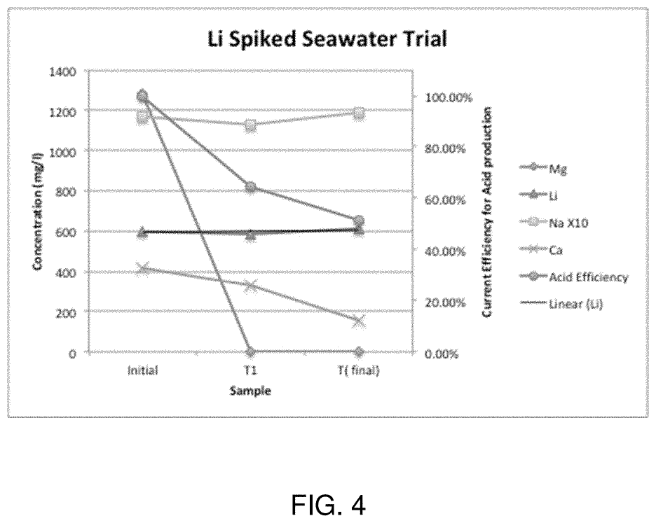

### DESCRIPTION OF EMBODIMENTS

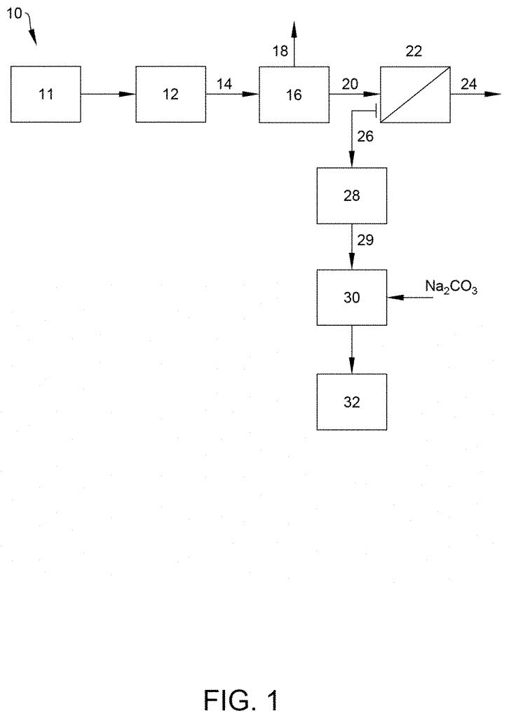

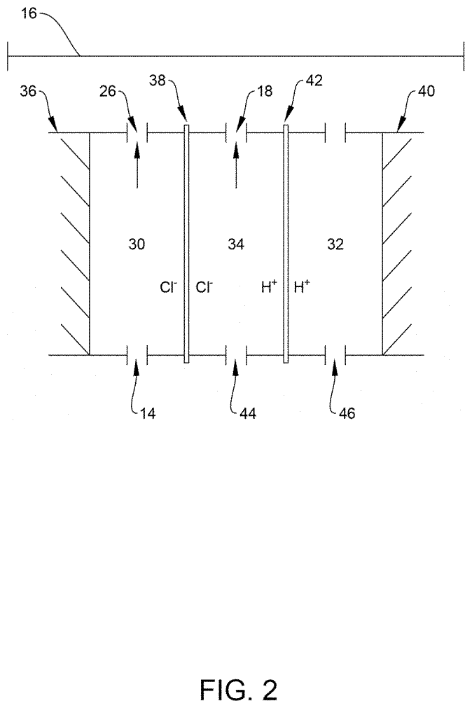

A description of the flowsheet for the present invention is described with reference to FIG. 1 and FIG. 2.

A flowsheet 10 for treating a lithium containing metallurgical solution is shown in FIG. 1. A lithium containing metallurgical solution 11, for example a hard rock ore or salar brine resource is subjected to a preparation and leaching step 12 using known processes to generate a lithium leach solution 14 containing chloride and impurities, for example, magnesium. The lithium leach solution 14 is directed to an electrochemical magnesium removal step 16, for example an electro/electrodialysis step, to generate a hydrochloric acid stream 18, and a stream 20 which undergoes a separation 22, either by a separate solid/liquid separation step or through use of an inline filter, to remove magnesium hydroxide precipitate 24 and produce a magnesium depleted lithium leach solution 26. The magnesium depleted lithium leach solution 26 then progresses to a concentration step 28 using conventional means such as membrane distillation, reverse osmosis, electrodialysis or evaporation. The concentrated lithium solution 29 that results, is then subjected to a recovery step using the known process of addition of sodium carbonate 30 to produce lithium carbonate 32.

The electrochemical magnesium removal step 16 is a key change to the overall lithium recovery flowsheet and is shown in further detail in FIG. 2. Where described features are the same as those in FIG. 1, they are depicted using like numbers.

The magnesium removal step 16, in the form of an electrochemical cell, for example an electro/electrodialysis configuration, comprises a cathode chamber 30, an anode chamber 32 and a central chamber 34. A cathode 36 is located in, or forms a boundary to the cathode chamber 30 and an anion exchange membrane 38 forms an adjoining boundary between the cathode chamber 30 and the central chamber 34. An anode 40 is located in, or forms a boundary to the anode chamber 32 and a cation exchange membrane 42 forms an adjoining boundary between the anode chamber 32 and the central chamber 34.

The lithium leach solution 14, is fed to the cathode chamber 30. Hydroxide ions are produced at the cathode 36 and react with magnesium present in the lithium leach solution 14 to form hydroxide precipitate/s that settle out of solution. Hydrogen gas produced at the cathode 36 prevents the hydroxide precipitate from fouling the cathode 36.

Hydrochloric acid solution 44, is fed to the central chamber 34. Chloride ions present in the lithium leach solution 14 proceed to migrate across the anion exchange membrane 38 into the central chamber 34. A sulfuric acid electrolyte solution 46 is fed to the anode chamber 32, where hydrogen ions are formed and proceed to migrate across the cation exchange membrane 42 into the central chamber 34. These hydrogen ions form hydrochloric acid (HCl) with the chloride ions that have migrated into the central chamber 34 across the anion exchange membrane 38. This results in a more concentrated hydrochloric acid stream 18 which can be reused or sold. Traditional methods would not result in a useful or valuable HCl stream.

With the magnesium having precipitated as the hydroxide in the cathode chamber 30 and having undergone separation, the magnesium depleted lithium solution 26 is formed and can then be directed to further processing as described above in relation to FIG. 1.

The method of the present invention has several advantages over traditional methods for removal of impurities such as magnesium from solutions. The 3-chamber configuration enables chloride to be removed from the feed solution (lithium leach solution) to produce hydrochloric acid (HCl) and magnesium to be precipitated as magnesium hydroxide, which are both potentially revenue generating streams not available to traditional treatment processes. Magnesium sulfate is removed enabling better lithium recoveries and minimizing lithium losses to waste streams (i.e. potentially higher lithium recoveries).

The 3-chamber configuration prevents the formation of chlorine, which is a further advantage over the electrochemical methods of the prior art that use a single membrane configuration. This has significant safety and environmental implications for commercial application.

The proposed flow sheet of the present invention offers potential for higher lithium recovery, combined with a very large reduction in processing costs, including through the minimization or elimination of the requirement to add soda ash, elimination of other solution purification costs, and of the concentration requirements for lithium carbonate recovery.

### EXAMPLES

### Example 1

1 litre of solution with 2800 mg Magnesium; 617 mg Li; 4190 mg Na; and balance as Chloride was electrolysed for 2 hours with 4.5 amps.

The cell was as described in the present invention, with two membranes, acid was recovered in the middle chamber by receiving chloride from the cathode chamber via the anion exchange (AX) membrane and hydrogen ions from the anode chamber via the cation exchange (CX) membrane, magnesium was precipitated in the cathode chamber—passed out of the cell and settled in the batch recycle container; sulphuric acid was used as supporting anolyte—water was electrolysed producing oxygen and hydrogen ions at the anode, and hydrogen and hydroxide ions at the cathode.

The results from this test are depicted in FIG. 2. After 2 hours passing 4.5 amperes, magnesium was reduced to 0.7 mg; Li was effectively unchanged, sodium was unchanged, and 9 grams of HCl was generated (73% current efficiency).

### Example 2

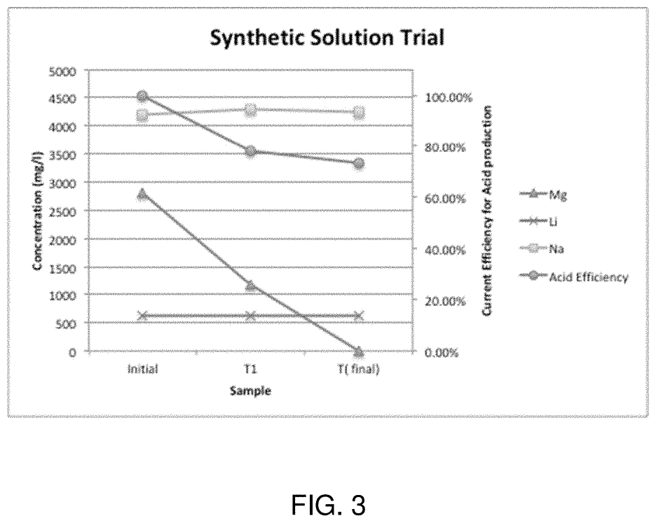

This experiment was performed the same as Example 1, but this time using Lithium spiked seawater (real impurities rather than a synthetic solution) as a feed solution. The results are depicted below and in FIG. 3.

| Sample | Mg | Ca | Li | Na X10 | |
|---|---|---|---|---|---|
| Initial | 1280 | 420 | 601 | 1170 | 100.00% |
| T1 | 0.1 | 327 | 585 | 1130 | 64.63% |
| T (final) | 0 | 153 | 612 | 1190 | 51.41% |

6.3 g of HCl was generated (51.4% current efficiency).

### Example 3

A 10 litre sample of seawater was fortified to an approximate composition of:

### Na—96.0 g/L

### K—5.8 g/L

### Li—0.5 g/L

### Mg—1.7 g/L

### Ca—0.5 g/L

### SO4—11.6 g/L

### Cl—155.7 g/L

### B—0.5 g/L

The solution was electrolysed for 11 hours at 5 amps. 91.5% of magnesium was removed, final solution was at pH >11; approximately 45% of calcium was removed; magnesium settles very satisfactorily; 44.48 g of HCl was generated reflecting an overall current efficiency of ˜61%

Modifications and variations such as would be apparent to the skilled addressee are considered to fall within the scope of the present invention.

1. A method for improved processing of lithium metallurgical solutions comprising the steps of:
i. Directing a lithium leach solution containing magnesium to an electrochemical magnesium removal step to form a magnesium depleted lithium leach solution;
ii. Directing the magnesium depleted lithium leach solution of step i) to downstream concentration and recovery processes
wherein the electrochemical magnesium removal step is a 3-chamber electrochemical configuration comprising a cathode chamber, a central chamber having an anion exchange membrane forming boundary to a cathode chamber and the central chamber, and a cation exchange membrane forming boundary to the anode chamber and central chamber to produce magnesium hydroxide precipitate and a separate hydrochloric acid stream, as recoverable by-products.

2. A method for improved processing of lithium metallurgical solutions comprising the steps of:
i. Directing a lithium leach solution containing magnesium to an electrochemical magnesium removal step to form a magnesium depleted lithium leach solution;
ii. Directing the magnesium depleted lithium leach solution of step i) to downstream concentration and recovery processes
wherein the electrochemical magnesium removal step is a 3-chamber electro/electrodialysis configuration comprising a cathode chamber, a central chamber having an anion exchange membrane forming boundary to a cathode chamber and the central chamber, and a cation exchange membrane forming boundary to the anode chamber and central chamber to produce magnesium hydroxide precipitate and a separate hydrochloric acid stream, as recoverable by-products.

3. A method for improved processing of lithium metallurgical solutions comprising the steps of:
i. Directing a lithium leach solution containing magnesium to an electrochemical magnesium removal step to form a magnesium depleted lithium leach solution;
ii. Directing the magnesium depleted lithium leach solution of step i) to downstream concentration and recovery processes
wherein the electrochemical magnesium removal step is a single stage 3-chamber electro/electrodialysis configuration comprising a cathode chamber, a central chamber having an anion exchange membrane forming boundary to a cathode chamber and the central chamber, and a cation exchange membrane forming boundary to the anode chamber and central chamber to produce magnesium hydroxide precipitate and a separate hydrochloric acid stream, as recoverable waste products.

4. An improved method for treating lithium leach solutions, comprising:
i. Directing a lithium leach solution containing magnesium to an electrochemical magnesium removal step to form a magnesium depleted lithium leach solution;
ii. Directing the magnesium depleted lithium leach solution of step i) to a polishing step to produce a treated pregnant leach solution (PLS); and
iii. Directing the treated PLS to conventional concentration and recovery steps to recover lithium as lithium carbonate;
wherein the magnesium removal step further comprises:
Directing the lithium leach solution of step i) to a cathode chamber of an electrochemical cell containing a cathode;
Directing a sulfuric acid electrolyte solution to an anode chamber containing an anode;
Separating the anode chamber from the cathode chamber with a central chamber, to form a 3-chamber cell, having an anion exchange membrane forming a boundary to the cathode chamber and the central chamber, and a cation exchange membrane forming a boundary to the anode chamber and the central chamber;
Directing a dilute hydrochloric acid solution to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid;
Precipitating magnesium as magnesium hydroxide in the cathode chamber to produce the magnesium depleted lithium solution.

5. A method for improved recovery of lithium from lithium leach solutions, comprising:
i. Directing a lithium leach solution containing magnesium to an electrochemical magnesium removal step to form a magnesium depleted lithium leach solution, a magnesium hydroxide precipitate and a separate hydrochloric acid stream;
ii. Separating the magnesium hydroxide from the magnesium depleted lithium leach solution in a solid/liquid separation step;
iii. Directing the separated magnesium depleted lithium leach solution of step ii) to a polishing step to produce a treated pregnant leach solution (PLS);
iv. Directing the treated PLS to conventional concentration and recovery steps to recover lithium as lithium carbonate;
wherein the magnesium removal step further comprises:
Directing the lithium leach solution of step i) to a 3-chamber electrochemical cell comprising a cathode chamber, an anode chamber, and a central chamber situated therebetween and having an anion exchange membrane forming a boundary to the cathode chamber and the central chamber, and a cation exchange membrane forming a boundary to the anode chamber and the central chamber;
Feeding the lithium leach solution of step i) to the cathode chamber containing a cathode;
Directing a sulphuric acid electrolyte solution to the anode chamber containing an anode;
Directing a hydrochloric acid solution to the central chamber;
Applying a current across the anode and cathode to facilitate hydrogen ions generated at the anode to migrate through the cation exchange membrane into the central chamber, and chloride ions generated in the cathode chamber to migrate across the anion exchange membrane to the central chamber to form hydrochloric acid;
Precipitating magnesium as magnesium hydroxide in the cathode chamber to produce the magnesium depleted lithium solution.

6-9. (canceled)

10. The method of claim 1 wherein the method is adapted for processing lithium metallurgical solutions as a stand-alone cell.

11. The method of claim 2, wherein the method is adapted for processing lithium metallurgical solutions as a stand-alone cell.

12. The method of claim 3, wherein the method is adapted for processing lithium metallurgical solutions as a stand-alone cell.

13. The method of claim 1, wherein the method is adapted for processing lithium metallurgical solutions as part of an inline continuous flow processing operation.

14. The method of claim 2, wherein the method is adapted for processing lithium metallurgical solutions as part of an inline continuous flow processing operation.

15. The method of claim 3, wherein the method is adapted for processing lithium metallurgical solutions as part of an inline continuous flow processing operation.

16. The method of claim 4, wherein the method is adapted for recovery of lithium from lithium leach solutions as a stand-alone cell.

17. The method of claim 5, wherein the method is adapted for recovery of lithium from lithium leach solutions as a stand-alone cell.

18. The method of claim 4, wherein the method is adapted for recovery of lithium from lithium leach solutions as part of an inline continuous flow processing operation.

19. The method of claim 5, wherein the method is adapted for recovery of lithium from lithium leach solutions as part of an inline continuous flow processing operation.
